(19) United States
(12) Patent Application Publication
(10) Pub. No.: US 2026/0136391 A1
(43) Pub. Date: May 14, 2026

(54) RESOURCE RESERVATION ENHANCEMENTS

(71) Applicant: Nokia Technologies Oy, Espoo (FI)

(72) Inventors: Nuno Manuel KIILERICH PRATAS, Aalborg (DK); Oana-Elena BARBU, Aalborg (DK); Benny VEJLGAARD, Aalborg (DK)

(73) Assignee: Nokia Technologies Oy, Espoo (FI)

(21) Appl. No.: 19/119,299

(22) PCT Filed: Oct. 11, 2023
(86) PCT No.: PCT/IB2023/060246

§ 371 Date: Apr. 8, 2025

(30) Foreign Application Priority Data
Oct. 12, 2022 (FI) 20225921

(51) Int. Cl. H04W 74/0816; H04W 24/08; H04W 28/26; H04W 72/02

(52) U.S. Cl. CPC H04W 74/0816; H04W 24/08; H04W 28/26; H04W 72/02

(57) ABSTRACT

Disclosed is a method comprising determining available resources in a resource pool based at least partly on channel sensing or channel occupancy information; creating, based on the available resources, a set of candidate resources comprising one or more first resources suitable for a first transmission from a first device to a second device, and one or more second resources suitable for a second transmission from the second device to the first device or to a third device; selecting a subset of resources from the set of candidate resources, wherein the subset of resources comprises at least one first resource for the first transmission and at least one second resource for the second transmission; and transmitting the first transmission to the second device in the at least one first resource, wherein the first transmission indicates the at least one second resource for the second transmission from the second device.

### FIELD

The following example embodiments relate to wireless communication.

### BACKGROUND

In wireless communication systems, in various wireless applications/services, in device-to-device communication, or in related systems, there may be apparatuses or nodes with different capabilities, for example, with different operating power/energy or with different signal processing capabilities. For example, in wireless systems related to internet of things, there may be passive devices that support communication with another device, for example, in part, via reflection or similar signal reception/transmission techniques. There is a challenge in, for example, how to use at least a part of device resources of a communication for the purpose of the passive internet of things.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided a first device comprising at least one processor, and at least one memory storing instructions which, when executed by the at least one processor, cause the first device at least to: determine available resources in a resource pool based at least partly on channel sensing or channel occupancy information; create, based on the available resources, a set of candidate resources comprising one or more first resources suitable for a first transmission from the first device to a second device, and one or more second resources suitable for a second transmission from the second device to the first device or to a third device; select a subset of resources from the set of candidate resources, wherein the subset of resources comprises at least one first resource for the first transmission and at least one second resource for the second transmission; and transmit the first transmission to the second device in the at least one first resource, wherein the first transmission indicates the at least one second resource for the second transmission from the second device.

According to another aspect, there is provided a first device comprising: means for determining available resources in a resource pool based at least partly on channel sensing or channel occupancy information; means for creating, based on the available resources, a set of candidate resources comprising one or more first resources suitable for a first transmission from the first device to a second device, and one or more second resources suitable for a second transmission from the second device to the first device or to a third device; means for selecting a subset of resources from the set of candidate resources, wherein the subset of resources comprises at least one first resource for the first transmission and at least one second resource for the second transmission; and means for transmitting the first transmission to the second device in the at least one first resource, wherein the first transmission indicates the at least one second resource for the second transmission from the second device.

According to another aspect, there is provided a method comprising: determining, by a first device, available resources in a resource pool based at least partly on channel sensing or channel occupancy information; creating, by the first device, based on the available resources, a set of candidate resources comprising one or more first resources suitable for a first transmission from the first device to a second device, and one or more second resources suitable for a second transmission from the second device to the first device or to a third device; selecting, by the first device, a subset of resources from the set of candidate resources, wherein the subset of resources comprises at least one first resource for the first transmission and at least one second resource for the second transmission; and transmitting, by the first device, the first transmission to the second device in the at least one first resource, wherein the first transmission indicates the at least one second resource for the second transmission from the second device.

According to another aspect, there is provided a computer program comprising instructions which, when executed by a first device, cause the first device to perform at least the following: determining available resources in a resource pool based at least partly on channel sensing or channel occupancy information; creating, based on the available resources, a set of candidate resources comprising one or more first resources suitable for a first transmission from the first device to a second device, and one or more second resources suitable for a second transmission from the second device to the first device or to a third device; selecting a subset of resources from the set of candidate resources, wherein the subset of resources comprises at least one first resource for the first transmission and at least one second resource for the second transmission; and transmitting the first transmission to the second device in the at least one first resource, wherein the first transmission indicates the at least one second resource for the second transmission from the second device.

According to another aspect, there is provided a computer readable medium comprising program instructions which, when executed by a first device, cause the first device to perform at least the following: determining available resources in a resource pool based at least partly on channel sensing or channel occupancy information; creating, based on the available resources, a set of candidate resources comprising one or more first resources suitable for a first transmission from the first device to a second device, and one or more second resources suitable for a second transmission from the second device to the first device or to a third device; selecting a subset of resources from the set of candidate resources, wherein the subset of resources comprises at least one first resource for the first transmission and at least one second resource for the second transmission; and transmitting the first transmission to the second device in the at least one first resource, wherein the first transmission indicates the at least one second resource for the second transmission from the second device.

According to another aspect, there is provided a non-transitory computer readable medium comprising program instructions which, when executed by a first device, cause the first device to perform at least the following: determining available resources in a resource pool based at least partly on channel sensing or channel occupancy information; creating, based on the available resources, a set of candidate resources comprising one or more first resources suitable for a first transmission from the first device to a second device, and one or more second resources suitable for a second transmission from the second device to the first device or to a third device; selecting a subset of resources from the set of candidate resources, wherein the subset of resources comprises at least one first resource for the first transmission and at least one second resource for the second transmission; and transmitting the first transmission to the second device in the at least one first resource, wherein the first transmission indicates the at least one second resource for the second transmission from the second device.

According to another aspect, there is provided a first device comprising at least one processor, and at least one memory storing instructions which, when executed by the at least one processor, cause the first device at least to: determine available resources in a resource pool based at least partly on channel sensing or channel occupancy information; determine that at least a third device has reserved at least one first resource for a first transmission from the third device to a second device and at least one second resource for a second transmission from the second device; monitor for the second transmission from the second device in the at least one second resource reserved by the third device; and receive the second transmission from the second device in the at least one second resource reserved by the third device.

According to another aspect, there is provided a first device comprising: means for determining available resources in a resource pool based at least partly on channel sensing or channel occupancy information; means for determining that at least a third device has reserved at least one first resource for a first transmission from the third device to a second device and at least one second resource for a second transmission from the second device; means for monitoring for the second transmission from the second device in the at least one second resource reserved by the third device; and means for receiving the second transmission from the second device in the at least one second resource reserved by the third device.

According to another aspect, there is provided a method comprising: determining, by a first device, available resources in a resource pool based at least partly on channel sensing or channel occupancy information; determining, by the first device, that at least a third device has reserved at least one first resource for a first transmission from the third device to a second device and at least one second resource for a second transmission from the second device; monitoring, by the first device, for the second transmission from the second device in the at least one second resource reserved by the third device; and receiving, by the first device, the second transmission from the second device in the at least one second resource reserved by the third device.

According to another aspect, there is provided a computer program comprising instructions which, when executed by a first device, cause the first device to perform at least the following: determining available resources in a resource pool based at least partly on channel sensing or channel occupancy information; determining that at least a third device has reserved at least one first resource for a first transmission from the third device to a second device and at least one second resource for a second transmission from the second device; monitoring for the second transmission from the second device in the at least one second resource reserved by the third device; and receiving the second transmission from the second device in the at least one second resource reserved by the third device.

According to another aspect, there is provided a computer readable medium comprising program instructions which, when executed by a first device, cause the first device to perform at least the following: determining available resources in a resource pool based at least partly on channel sensing or channel occupancy information; determining that at least a third device has reserved at least one first resource for a first transmission from the third device to a second device and at least one second resource for a second transmission from the second device; monitoring for the second transmission from the second device in the at least one second resource reserved by the third device; and receiving the second transmission from the second device in the at least one second resource reserved by the third device.

According to another aspect, there is provided a non-transitory computer readable medium comprising program instructions which, when executed by a first device, cause the first device to perform at least the following: determining available resources in a resource pool based at least partly on channel sensing or channel occupancy information; determining that at least a third device has reserved at least one first resource for a first transmission from the third device to a second device and at least one second resource for a second transmission from the second device; monitoring for the second transmission from the second device in the at least one second resource reserved by the third device; and receiving the second transmission from the second device in the at least one second resource reserved by the third device.

According to another aspect, there is provided a second device comprising at least one processor, and at least one memory storing instructions which, when executed by the at least one processor, cause the second device at least to: monitor a resource pool for a first transmission from a first device; determine whether the first transmission received from the first device comprises a charging signal or an activation signal; and perform one of the following: continue to monitor the resource pool for an additional charging signal or for the activation signal from the first device based on determining that the first transmission comprises the charging signal, or transmit a second transmission in at least one resource indicated by the activation signal based on determining that the first transmission comprises the activation signal.

According to another aspect, there is provided a second device comprising: means for monitoring a resource pool for a first transmission from a first device; means for determining whether the first transmission received from the first device comprises a charging signal or an activation signal; and means for performing one of the following: continuing to monitor the resource pool for an additional charging signal or for the activation signal from the first device based on determining that the first transmission comprises the charging signal, or transmitting a second transmission in at least one resource indicated by the activation signal based on determining that the first transmission comprises the activation signal.

According to another aspect, there is provided a method comprising: monitoring, by a second device, a resource pool for a first transmission from a first device; determining, by the second device, whether the first transmission received from the first device comprises a charging signal or an activation signal; and performing, by the second device, one of the following: continuing to monitor the resource pool for an additional charging signal or for the activation signal from the first device based on determining that the first transmission comprises the charging signal, or transmitting a second transmission in at least one resource indicated by the activation signal based on determining that the first transmission comprises the activation signal.

According to another aspect, there is provided a computer program comprising instructions which, when executed by a second device, cause the second device to perform at least the following: monitoring a resource pool for a first transmission from a first device; determining whether the first transmission received from the first device comprises a charging signal or an activation signal; and performing one of the following: continuing to monitor the resource pool for an additional charging signal or for the activation signal from the first device based on determining that the first transmission comprises the charging signal, or transmitting a second transmission in at least one resource indicated by the activation signal based on determining that the first transmission comprises the activation signal.

According to another aspect, there is provided a computer readable medium comprising program instructions which, when executed by a second device, cause the second device to perform at least the following: monitoring a resource pool for a first transmission from a first device; determining whether the first transmission received from the first device comprises a charging signal or an activation signal; and performing one of the following: continuing to monitor the resource pool for an additional charging signal or for the activation signal from the first device based on determining that the first transmission comprises the charging signal, or transmitting a second transmission in at least one resource indicated by the activation signal based on determining that the first transmission comprises the activation signal.

According to another aspect, there is provided a non-transitory computer readable medium comprising program instructions which, when executed by a second device, cause the second device to perform at least the following: monitoring a resource pool for a first transmission from a first device; determining whether the first transmission received from the first device comprises a charging signal or an activation signal; and performing one of the following: continuing to monitor the resource pool for an additional charging signal or for the activation signal from the first device based on determining that the first transmission comprises the charging signal, or transmitting a second transmission in at least one resource indicated by the activation signal based on determining that the first transmission comprises the activation signal.

According to another aspect, there is provided a third device comprising at least one processor, and at least one memory storing instructions which, when executed by the at least one processor, cause the third device at least to: monitor a resource pool for a first transmission from a first device to a second device; detect the first transmission, wherein the first transmission indicates at least one resource for a second transmission from the second device; and monitor for the second transmission from the second device in the at least one resource.

According to another aspect, there is provided a third device comprising: means for monitoring a resource pool for a first transmission from a first device to a second device; means for detecting the first transmission, wherein the first transmission indicates at least one resource for a second transmission from the second device; and means for monitoring for the second transmission from the second device in the at least one resource.

According to another aspect, there is provided a method comprising: monitoring, by a third device, a resource pool for a first transmission from a first device to a second device; detecting, by the third device, the first transmission, wherein the first transmission indicates at least one resource for a second transmission from the second device; and monitoring, by the third device, for the second transmission from the second device in the at least one resource.

According to another aspect, there is provided a computer program comprising instructions which, when executed by a third device, cause the third device to perform at least the following: monitoring a resource pool for a first transmission from a first device to a second device; detecting the first transmission, wherein the first transmission indicates at least one resource for a second transmission from the second device; and monitoring for the second transmission from the second device in the at least one resource.

According to another aspect, there is provided a computer readable medium comprising program instructions which, when executed by a third device, cause the third device to perform at least the following: monitoring a resource pool for a first transmission from a first device to a second device; detecting the first transmission, wherein the first transmission indicates at least one resource for a second transmission from the second device; and monitoring for the second transmission from the second device in the at least one resource.

According to another aspect, there is provided a non-transitory computer readable medium comprising program instructions which, when executed by a third device, cause the third device to perform at least the following: monitoring a resource pool for a first transmission from a first device to a second device; detecting the first transmission, wherein the first transmission indicates at least one resource for a second transmission from the second device; and monitoring for the second transmission from the second device in the at least one resource.

According to another aspect, there is provided a fourth device comprising at least one processor, and at least one memory storing instructions which, when executed by the at least one processor, cause the fourth device at least to: determine available resources in a resource pool based at least partly on channel sensing or channel occupancy information; create, based on the available resources, a set of candidate resources comprising one or more resources suitable for a first transmission from the fourth device, wherein resources associated with transmissions from one or more passive devices are excluded from the set of candidate resources; select a subset of resources from the set of candidate resources, wherein the subset of resources comprises at least one resource for the first transmission; and transmit the first transmission in the at least one resource.

According to another aspect, there is provided a fourth device comprising: means for determining available resources in a resource pool based at least partly on channel sensing or channel occupancy information; means for creating, based on the available resources, a set of candidate resources comprising one or more resources suitable for a first transmission from the fourth device, wherein resources associated with transmissions from one or more passive devices are excluded from the set of candidate resources; means for selecting a subset of resources from the set of candidate resources, wherein the subset of resources comprises at least one resource for the first transmission; and means for transmitting the first transmission in the at least one resource.

According to another aspect, there is provided a method comprising: determining, by a fourth device, available resources in a resource pool based at least partly on channel sensing or channel occupancy information; creating, by the fourth device, based on the available resources, a set of candidate resources comprising one or more resources suitable for a first transmission from the fourth device, wherein resources associated with transmissions from one or more passive devices are excluded from the set of candidate resources; selecting, by the fourth device, a subset of resources from the set of candidate resources, wherein the subset of resources comprises at least one resource for the first transmission; and transmitting, by the fourth device, the first transmission in the at least one resource.

According to another aspect, there is provided a computer program comprising instructions which, when executed by a fourth device, cause the fourth device to perform at least the following: determining available resources in a resource pool based at least partly on channel sensing or channel occupancy information; creating, based on the available resources, a set of candidate resources comprising one or more resources suitable for a first transmission from the fourth device, wherein resources associated with transmissions from one or more passive devices are excluded from the set of candidate resources; selecting a subset of resources from the set of candidate resources, wherein the subset of resources comprises at least one resource for the first transmission; and transmitting the first transmission in the at least one resource.

According to another aspect, there is provided a computer readable medium comprising program instructions which, when executed by a fourth device, cause the fourth device to perform at least the following: determining available resources in a resource pool based at least partly on channel sensing or channel occupancy information; creating, based on the available resources, a set of candidate resources comprising one or more resources suitable for a first transmission from the fourth device, wherein resources associated with transmissions from one or more passive devices are excluded from the set of candidate resources; selecting a subset of resources from the set of candidate resources, wherein the subset of resources comprises at least one resource for the first transmission; and transmitting the first transmission in the at least one resource.

According to another aspect, there is provided a non-transitory computer readable medium comprising program instructions which, when executed by a fourth device, cause the fourth device to perform at least the following: determining available resources in a resource pool based at least partly on channel sensing or channel occupancy information; creating, based on the available resources, a set of candidate resources comprising one or more resources suitable for a first transmission from the fourth device, wherein resources associated with transmissions from one or more passive devices are excluded from the set of candidate resources; selecting a subset of resources from the set of candidate resources, wherein the subset of resources comprises at least one resource for the first transmission; and transmitting the first transmission in the at least one resource.

### LIST OF DRAWINGS

In the following, various example embodiments will be described in greater detail with reference to the accompanying drawings, in which

FIG. 1A illustrates an example of a cellular communication network;

FIG. 1B illustrates an example of a system;

FIG. 2A illustrates sidelink resource allocation mode 1;

FIG. 2B illustrates sidelink resource allocation mode 2;

FIG. 3A illustrates an example of a sidelink slot structure;

FIG. 3B illustrates an example of a sidelink slot structure;

FIG. 4A illustrates a signaling diagram;

FIG. 4B illustrates a signaling diagram;

FIG. 5 illustrates the relation between activation signal and passive signal resource allocations;

FIG. 6 illustrates a flow chart;

FIG. 7 illustrates a flow chart;

FIG. 8 illustrates a flow chart;

FIG. 9 illustrates a flow chart;

FIG. 10 illustrates a flow chart;

FIG. 11 illustrates a flow chart;

FIG. 12 illustrates a flow chart;

FIG. 13 illustrates a flow chart;

FIG. 14 illustrates a flow chart; and

FIG. 15 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

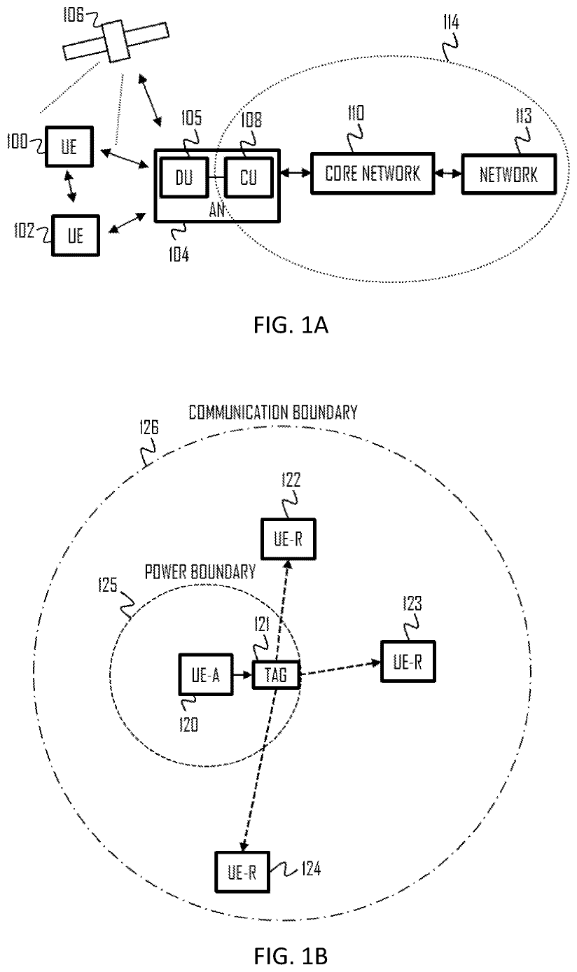

FIG. 1A depicts examples of simplified system architectures showing some elements and functional entities, all being logical units, whose implementation may differ from what is shown. The connections shown in FIG. 1A are logical connections; the actual physical connections may be different. It is apparent to a person skilled in the art that the system may also comprise other functions and structures than those shown in FIG. 1A.

The example embodiments are not, however, restricted to the system given as an example but a person skilled in the art may apply the solution to other communication systems provided with necessary properties.

The example of FIG. 1A shows a part of an exemplifying radio access network.

FIG. 1A shows user devices 100 and 102 configured to be in a wireless connection on one or more communication channels in a radio cell with an access node (AN) 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes and also for routing data from one access node to another. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the deployed technology, the counterpart that the access node may be connected to on the CN side may be a serving gateway (S-GW, routing and forwarding user data packets), packet data network gateway (P-GW) for providing connectivity of user devices to external packet data networks, user plane function (UPF), mobility management entity (MME), or an access and mobility management function (AMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, reduced capability (RedCap) device, wireless sensor device, or any device integrated in a vehicle.

It should be appreciated that a user device may also be a nearly exclusive uplink-only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud or in another user device. The user device (or in some example embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1A) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with one or more other networks 113, such as a public switched telephone network or the Internet, or utilize services provided by them. The communication network may also be able to support the usage of cloud services, for example at least part of core network operations may be carried out as a cloud service (this is depicted in FIG. 1A by “cloud” 114). The communication system may also comprise a central control entity, or the like, providing facilities for networks of different operators to cooperate for example in spectrum sharing.

An access node may also be split into: a radio unit (RU) comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be defined as a logical node hosting higher layer protocols, such as radio resource control (RRC), service data adaptation protocol (SDAP) and/or packet data convergence protocol (PDCP), of the access node. The DU 105 may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU 108 and/or DU 105. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of functions between the above-mentioned access node units, or different core network operations and access node operations, may differ.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It is also possible that node operations may be distributed among a plurality of servers, nodes or hosts. Application of cloudRAN architecture enables RAN real-time functions being carried out at the RAN side (e.g., in a DU 105) and non-real-time functions being carried out in a centralized manner (e.g., in a CU 108).

It should also be understood that the distribution of functions between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). A given satellite 106 in the mega-constellation may cover several satellite-enabled network entities that create on-ground cells. The on-ground cells may be created through an on-ground relay node or by an access node 104 located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have access to a plurality of radio cells and the system may also comprise other apparatuses, such as physical layer relay nodes or other network elements, etc. At least one of the access nodes may be a Home eNodeB or a Home gNodeB.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1A may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1A). An HNB-GW, which may be installed within an operator's network, may aggregate traffic from a large number of Home eNodeBs or Home gNodeBs back to a core network.

Regarding IoT applications, the 3^{rd} generation partnership project (3GPP) has specified narrowband IoT (NB-IoT), enhanced machine type communication (eMTC), and NR reduced capability (RedCap) before NR Release 18 to satisfy the requirements on low-complexity and low-power devices for wide-area IoT communication. For example, these IoT devices may consume tens or hundreds of milliwatts of power during transceiving. However, to achieve the internet of everything, IoT devices with even lower power consumption may be needed, for example for applications requiring batteryless devices.

The number of IoT connections has been growing rapidly in recent years and is predicted to be hundreds of billions by 2030. With more and more ‘things’ expected to be interconnected for improving production efficiency and increasing the comforts of life, further reduction of size, complexity, and power consumption may be needed for IoT devices. For example, replacing the battery of IoT devices may be impractical due to the large consumption of materials and manpower.

Passive IoT devices (or a part of a UE operating, or part of a UE or device configured to operate as a passive IoT device) may support communication with a reader UE via reflection (backscattering) or similar, which may be supported by very low-complexity hardware. A passive IoT device may harvest energy from the environment, for example from radio frequency (RF) signals, solar energy, vibration, heat energy, etc., to power the passive IoT device for self-sustainable communication. A passive IoT device may potentially be equipped with a small-capacity battery or capacitor that may be charged with the harvested energy. Hence, passive IoT is a promising technique to achieve even lower power requirements compared to other cellular IoT technologies, such as NB-IoT, LTE-M, RedCap, etc. Passive IoT devices may also be referred to as passive devices or tags herein.

Radio-frequency identification (RFID) systems have emerged as a key technology for a variety of enterprise and consumer use cases, such as highway toll collection, livestock tagging, warehouse asset management, and retail theft deterrence. RFID tag devices may communicate via backscatter radio, wherein a transmitter illuminates the tag with an RF signal, the tag modulates the incoming RF signal, and the reflected signal arrives at a receiver. Thus, an RFID tag may operate without an active radio or local power source. However, the communication range of RFID systems may be short.

To overcome the challenge of short range between the tag and reader (receiver), backscatter IoT tag devices may operate under a multi-static architecture, where the transmitters and receivers are decoupled.

FIG. 1B illustrates an example of a system, to which some example embodiments may be applied. Referring to FIG. 1B, an IoT tag 121 reflects signals received from an activator UE (UE-A) 120, and the reflected signal is received by one or more reader UEs (UE-R) 122, 123, 124. The activator UE 120 may also have the role of receiver, in which case the activator UE 120 may also receive the reflected signal from the IoT tag 121. The IoT tag 121 may be within the power boundary 125 of the activator UE 120, and the one or more reader UEs 122, 123, 124 may be within the communication boundary 126 of the IoT tag 121. Similar to RFID, the IoT tag 121 may modulate the incoming signal with information, which may be conveyed to the one or more reader UEs 122, 123, 124 via backscatter reflection. For example, this information may comprise the identifier (ID) of the tag 121, and possibly also sensor information from attached sensors. The one or more reader UEs 122, 123, 124 may demodulate the reflected signal and extract the ID, thereby registering the presence of the tag 121. The one or more reader UEs 122, 123, 124 may also demodulate the sensor information, if it is included in the signal. In addition to backscatter communication, the system may also support the localization (positioning) of the backscatter tag 121 using RF measurements of the reflected tag signals. This multi-static architecture, when coupled with the higher antenna gains and higher transmit powers, may significantly extend the backscatter range compared to RFID systems.

In NR Release 16 and beyond, NR sidelink (SL) enables a UE to communicate directly with one or more other nearby UEs via sidelink communication. Two resource allocation modes have been specified for SL, and an SL transmitter (Tx) UE may be configured with one of them to perform its sidelink transmission(s). These modes are denoted as NR SL mode 1 and NR SL mode 2. In NR SL mode 1, a sidelink transmission resource is assigned by the network to the SL Tx UE, whereas an SL Tx UE in NR SL mode 2 autonomously selects its SL transmission resources.

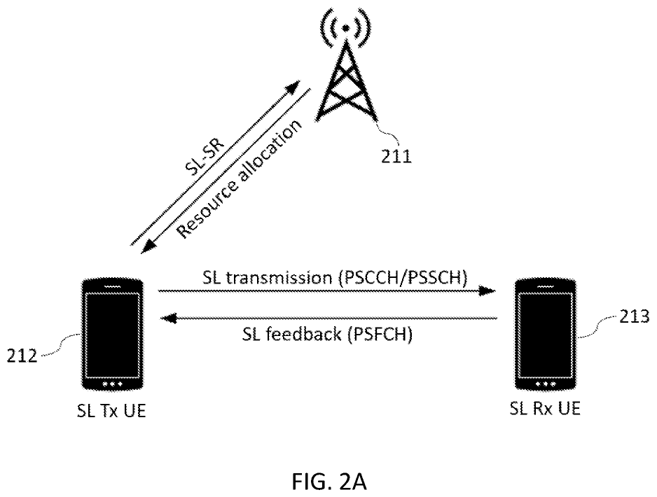

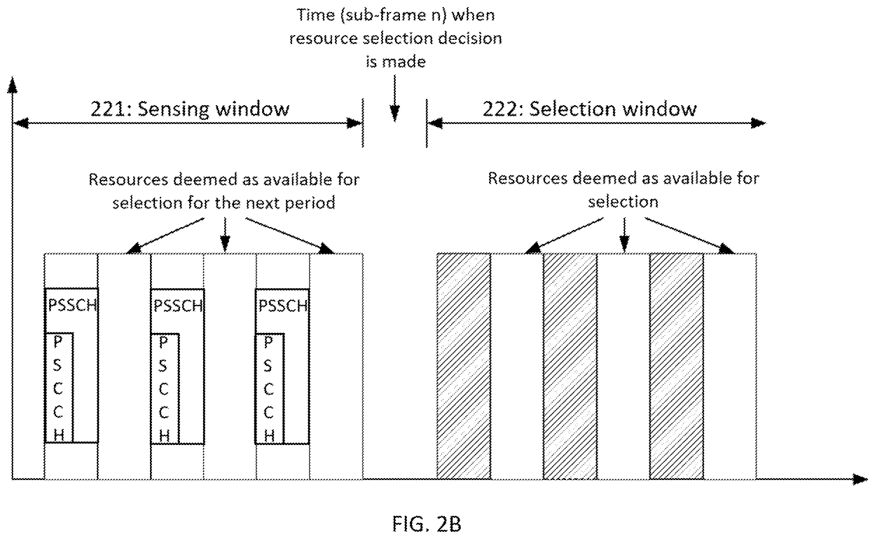

FIG. 2A illustrates NR SL mode 1. In NR SL mode 1, where the gNB 211 is responsible for the SL resource allocation for the SL UEs 212, 213, the configuration and operation is similar to the one over the Uu interface. Referring to FIG. 2A, an SL Tx UE 212 transmits a sidelink scheduling request (SL-SR) to the gNB 212. The gNB 211 indicates an SL resource allocation for the SL Tx UE 212 in response to the SL-SR. Upon receiving the SL resource allocation, the SL Tx UE 212 transmits an SL transmission to the SL Rx UE 213 based on the SL resource allocation via a physical sidelink control channel (PSCCH) or a physical sidelink shared channel (PSSCH). In response to the SL transmission, the SL Rx UE 213 transmits an SL feedback transmission to the SL Tx UE 212 via a physical sidelink feedback channel (PSFCH).

FIG. 2B illustrates NR SL mode 2. In NR SL mode 2, the SL UEs autonomously perform the resource selection with the aid of a sensing procedure. More specifically, an SL Tx UE in NR SL mode 2 first performs a sensing procedure over the configured SL transmission resource pool(s) during a sensing time window 221, in order to obtain knowledge of the resource(s) reserved by other nearby SL Tx UE(s). Based on the knowledge obtained from the sensing, the SL Tx UE may select resource(s) from the available SL resources accordingly during a selection time window 222. Resources deemed as available for selection for the next period may still need to have a listen-before-talk (LBT) check prior to access.

In order for an SL UE to perform sensing and obtain the necessary information to receive a SL transmission, it may need to decode the sidelink control information (SCI). In NR Release 16, the SCI associated with a data transmission includes a 1st stage SCI and a 2nd stage SCI. In other words, the SCI follows a two-stage SCI structure, whose main motivation is to support the size difference between the SCIs for various NR vehicle-to-everything (V2X) SL service types (e.g., broadcast, groupcast, and unicast).

The 1st stage SCI, SCI format 1-A, is carried by PSCCH and contains information to enable sensing operations, and information needed to determine resource allocation of the PSSCH and to decode the 2nd stage SCI.

In other words, SCI format 1-A may be used for the scheduling of PSSCH and 2nd stage SCI on PSSCH. The following information may be transmitted by means of the SCI format 1-A:
Priority: 3 bits.
Frequency resource assignment:

$$⌈ {log}_{2} ( \frac{{N}_{subChannel}^{SL} ( {N}_{subChannel}^{SL} + 1 )}{2} ) ⌉ bits$$

when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits$$

when the value of the higher layer parameter sl-MaxNumPerReserve is configured to 3.

$${N}_{subchannel}^{SL}$$

is the number of sub-channels in a resource pool provided according to the higher layer parameter sl-NumSubchannel.
Time resource assignment: 5 bits when the value of the higher layer parameter sl-MaxNumPerReserve is configured to 2; otherwise 9 bits when the value of the higher layer parameter sl-MaxNumPerReserve is configured to 3.
Resource reservation period: ┌log₂ N_{rsv_period}┐ bits, where N_{rsv_period} is the number of entries in the higher layer parameter sl-ResourceReservePeriodList, if the higher layer parameter sl-MultiReserveResource is configured; 0 bit otherwise.
Demodulation reference signal (DMRS) pattern—┌log₂ Nₚₐₜₜₑᵣₙ┐ bits, where Nₚₐₜₜₑᵣₙ is the number of DMRS patterns configured by the higher layer parameter sl-PSSCH-DMRS-TimePatternList; 0 bit if sl-PSSCH-DMRS-TimePatternList is not configured.
2^{nd} stage SCI format: 2 bits as defined in Table 1 below.
Beta_offset indicator: 2 bits as provided by the higher layer parameter sl-BetaOffsets2ndSCI and Table 2 below.
Number of DMRS port: 1 bit as defined in Table 3 below.
Modulation and coding scheme (MCS): 5 bits.
Additional MCS table indicator: 1 bit if one MCS table is configured by the higher layer parameter sl-Additional-MCS-Table; 2 bits if two MCS tables are configured by the higher layer parameter sl- Additional-MCS-Table; 0 bit otherwise.
PSFCH overhead indication: 1 bit if the higher layer parameter sl-PSFCH-Period is 2 or 4; 0 bit otherwise.
Reserved: a number of bits as determined by the higher layer parameter sl-NumReservedBits, with value set to zero.

TABLE 1

| Value of 2^{nd} stage SCI format field | 2^{nd} stage SCI format |
|---|---|
| 00 | SCI format 2-A |
| 01 | SCI format 2-B |
| 10 | Reserved |
| 11 | Reserved |

The 2nd stage SCI, SCI format 2-A and 2-B, is carried by PSSCH (multiplexed with SL-SCH) and contains: source and destination identities, information to identify and decode the associated sidelink shared channel (SL-SCH) transport block (TB), control of hybrid automatic repeat request (HARQ) feedback in unicast/groupcast, and a trigger for channel state information (CSI) feedback in unicast.

SCI format 2-A may be used for the decoding of PSSCH, with HARQ operation when HARQ-ACK information includes an acknowledgement (ACK) or negative acknowledgement (NACK), or when there is no feedback of HARQ-ACK information. The following information may be transmitted by means of the SCI format 2-A:
HARQ process number: 4 bits
New data indicator: 1 bit
Redundancy version: 2 bits
Source ID: 8 bits
Destination ID: 16 bits
HARQ feedback enabled/disabled indicator: 1 bit
Cast type indicator: 2 bits as defined in Table 4 below
CSI request: 1 bit

TABLE 2

| Value of Cast type indicator | Cast type |
|---|---|
| 00 | Broadcast |
| 01 | Groupcast |
| 10 | Unicast |
| 11 | Reserved |

SCI format 2-B may be used for the decoding of PSSCH, with HARQ operation when HARQ-ACK information includes only NACK, or when there is no feedback of HARQ-ACK information. The following information may be transmitted by means of the SCI format 2-B:
HARQ process number: 4 bits
New data indicator: 1 bit
Redundancy version: 2 bits
Source ID: 8 bits
Destination ID: 16 bits
HARQ feedback enabled/disabled indicator: 1 bit
Zone ID: 12 bits
Communication range requirement: 4 bits

Thus, SCI may indicate the information used for sensing purposes. For example, an SL Tx UE may transmit SCI and indicate the reserved sidelink resources to nearby UEs, and thus the nearby UEs can avoid using those reserved resources. In addition, the SCI may also contain information used to identify receiver(s) that should receive the data payload, for example by using the source ID and/or destination ID carried in the 2nd stage SCI.

The configuration of the resources in the sidelink resource pool defines the minimum information required for an SL Rx UE to be able to decode a transmission, which may include the number of sub-channels, the number of physical resource blocks (PRBs) per sub-channels, the number of symbols in the PSCCH, which slots have a PSFCH, and other configuration aspects.

However, the details of the actual sidelink transmission (i.e., the payload) may be provided in the PSCCH (1st stage SCI) for each individual transmission, which includes: the time and frequency resources, the DMRS configuration of the PSSCH, the modulation coding scheme (MCS), PSFCH, among others.

NR SL transmissions may make use of a demodulation reference signal (DMRS) to enable the SL Rx UE to decode the associated SL physical channel, i.e., PSCCH, PSSCH, or physical sidelink broadcast channel (PSBCH). The DMRS may be sent within the associated sidelink physical channel.

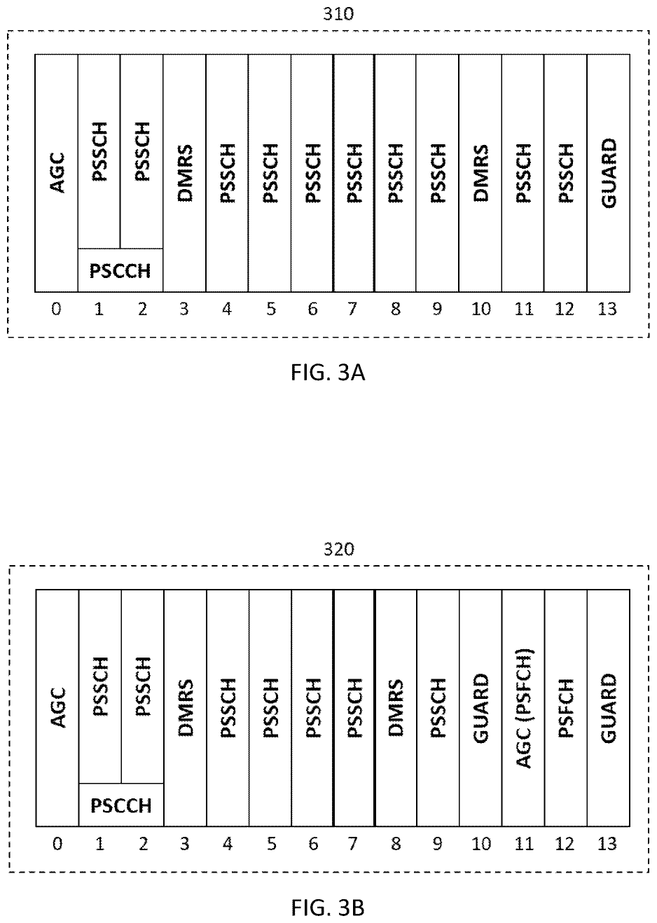

FIG. 3A illustrates an example of an SL slot structure 310 with PSCCH/PSSCH.

FIG. 3B illustrates an example of an SL slot structure 320 with PSCCH/PSSCH, where the last symbols are used for PSFCH.

In FIG. 3A and FIG. 3B, a PSSCH symbol with DMRS is shown as DMRS. The numbers 0-13 in FIGS. 3A and 3B refer to symbols in time domain.

The configuration of the PSCCH (e.g., DMRS, MCS, number of symbols used) is part of the resource pool configuration. Furthermore, the indication of which slots have PSFCH symbols may also be part of the resource pool configuration. However, the configuration of the PSSCH (e.g., the number of symbols used, the DMRS pattern and the MCS) may be provided by the 1st stage SCI, which is the payload sent within the PSCCH, and follows the configuration shown in Table 3 below.

For supporting different channel conditions, the DMRS associated with a PSSCH may be carried on different symbols, for example in 2, 3 or 4 SL symbols, within a PSSCH slot, i.e., with different time patterns. The different time patterns for the PSSCH DMRS may depend on the number of symbols for PSCCH, the number of symbols with PSSCH DMRS and the number of symbols for PSSCH within a slot. The time patterns currently supported for PSSCH DMRS in NR SL are listed in Table 3 below, where the position(s) of the DMRS symbols is given by l̅. Here, l_{d} is the duration of the scheduled resources for transmission of PSSCH and the associated PSCCH, including the orthogonal frequency-division multiplexing (OFDM) symbol duplicated. For a resource pool, one or more time patterns for PSSCH DMRS may be (pre-)configured. In case multiple patterns are (pre-)configured, the DMRS time pattern used in a PSSCH may be indicated in the associated 1st stage SCI.

TABLE 3

| | DMRS position l̅ | | | | | |
|---|---|---|---|---|---|---|
| l_{d} in | PSCCH duration 2 symbols | | | PSCCH duration 3 symbols | | |
| sym- | Number of PSSCH DMRS | | | Number of PSSCH DMRS | | |
| bols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

As described above, in NR SL mode 2, a given UE autonomously selects resources by decoding the PSCCH (or SCI) and performing reference signal received power (RSRP) measurement of (pre-)configured resource pool(s) based on a sensing procedure on a candidate resource pool during a sensing time window. The resource pool(s) comprise the available SL resources. For example, the resource pool(s) may comprise PRBs and slots that have been (pre-)configured for SL transmissions. The monitoring of the resource pool and acquisition of information to be used during the resource selection procedure may be done prior to the SL Tx UE knowing that it has a transmission to perform. After the SL Tx UE has acquired enough information from its monitoring of the resource pool, it can form the set of candidate resources.

The formation of the set of candidate resources occurs for resources within the candidate resource pool, which has been monitored during the sensing time window. During this sensing time window, the UE collects or identifies a set S_{A} of potential candidate resource slots that are within a defined selection time window and excludes all resources/slots, which: 1) the UE has not monitored during the sensing period (e.g., due to its own transmission or other activities including discontinuous reception, DRX); and 2) the decoded SCI format 1-A indicates that the candidate slot is reserved and the corresponding measured RSRP is above a pre-configured RSRP threshold.

If the number of remaining single slot candidates are greater than |X·S_{A}| (e.g., where X=0.2, 0.35, 0.5), the UE forwards the potential candidate slots to the higher layers for final resource selection. Otherwise, it increases the RSRP threshold by a step (i.e., RSRP threshold=RSRP threshold+step, where the step is currently defined to be 3 dB) and repeats the procedure. Final candidate slots are then forwarded to higher layers for final resource selection.

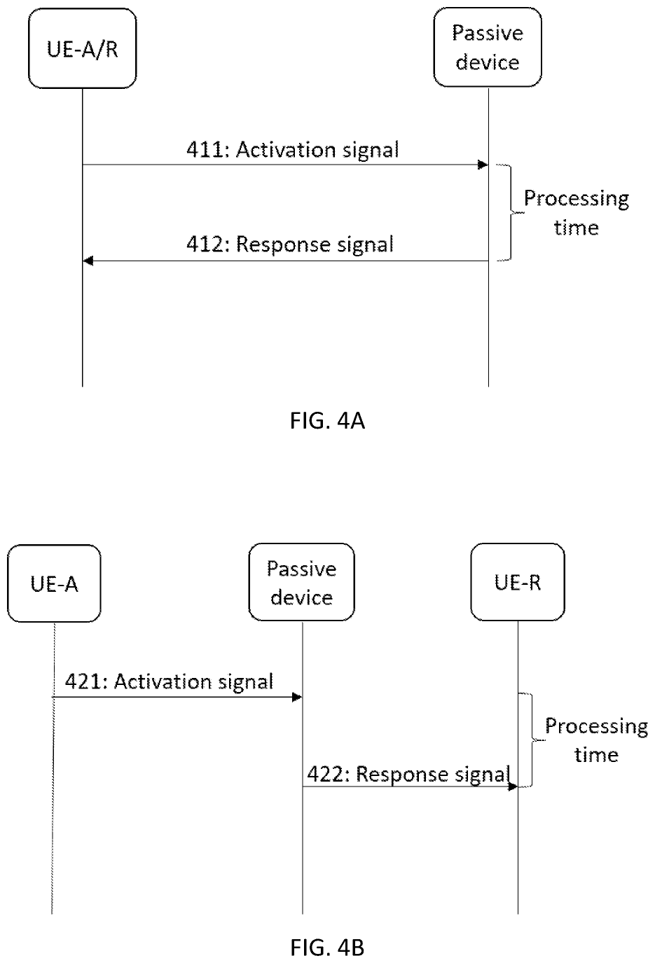

The interactions between an SL UE and a passive device may take place as depicted in FIG. 4A and FIG. 4B. FIG. 4A and FIG. 4B illustrate some examples of different types of sidelink passive IoT communications.

In FIG. 4A, the SL UE has both an activator and receiver/reader role (UE-A/R). The activator device is the one to select (e.g., based on user input or network trigger) when to initiate the transmission of the activation signal, while the passive device is expected to reply to this activation signal. UE-A/R may also be referred to as a first device herein. The passive device may also be referred to as a second device herein.

Referring to FIG. 4A, in block 411, the SL UE (UE-A/R) transmits an activation signal to a passive device. The main purpose of the activation signal is to indicate that the passive device should perform a transmission, as well as to indicate in which resource(s) the passive device should perform its transmission. The activation signal may also serve as a charging signal. Alternatively, there may be separate activation and charging signals. The passive device may harvest energy from the charging signal to charge a battery or a capacitor of the passive device.

In principle, any resource (or transmission) can be used for charging, including transmissions not related to the passive communications. However, if the only activity in the resource pool are the transmissions from the activator UE, then the activator UE may transmit the charging signal, for which the sole purpose may be to charge the passive device.

In one example, the passive device may be a simple tag that just replies to the activation signal (e.g., with a specific frequency or specific sequence) upon reception of the activation signal or after some delay from the reception of the activation signal (e.g., to allow the activator UE to transition from transmission mode to reception mode).

In another example, the passive device may be a more complex tag that demodulates and decodes the activation signal, and based on that is able to determine which resource(s) it should use to transmit its response signal. The more complex tag may comprise at least one processor and at least one memory.

In block 412, the passive device replies to the activation signal by transmitting a response signal to the SL UE. The reply may be transmitted after a certain processing time between the reception of the activation signal and the transmission of the response signal.

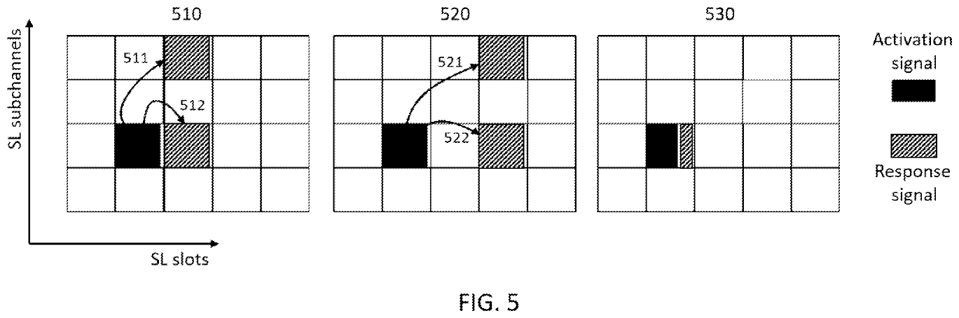

In one option, the passive device receives the charging/activation signal, and as soon as it has achieved enough charge, it may start its transmission immediately or after the charging/activation signal stops. The former case (immediate transmission) may correspond to the behavior depicted in block 530 of FIG. 5, while the latter case (after charging/activation signal stops) may correspond to the behavior depicted in block 510 of FIG. 5.

In another option, the passive device receives the charging/activation signal and charges. Then, based on the resource indication in the activation signal, the passive device determines the resource(s) that it should use for its transmission. This corresponds to the behavior depicted in in blocks 510 and 520 of FIG. 5.

In FIG. 4B, a first SL UE (UE-A) has the role of the activator, and a second SL UE (UE-R) has the role of the reader/receiver. UE-A may also be referred to as a first device herein. The passive device may also be referred to as a second device herein. UE-R may also be referred to as a third device herein.

Referring to FIG. 4B, in block 421, the first SL UE (UE-A) transmits an activation signal to a passive device.

In block 422, the passive device replies to the activation signal by transmitting a response signal to the second SL UE (UE-R) after a certain processing time between the reception of the activation signal and the transmission of the response signal.

Under the assumption that the activation signal and the response signal are transmitted in the same carrier (i.e., the passive device does not perform down-conversion or up-conversion of the operating frequency) and in the same sidelink resource pool, then in terms of mapping of the activation and response signals to the resources in a sidelink resource pool, there may be, for example, three resource allocation types as depicted in FIG. 5: Type A, Type B, and Type C.

FIG. 5 illustrates the relation between the activation signal and passive signal resource allocations.

In Type A 510, the activation signal and response signal occur in contiguous slots at the same sub-channel 512 or at different sub-channels 511.

In Type B 520, the activation signal and response signal occur at non-contiguous slots at the same sub-channel 522 or at different sub-channels 521.

In Type C 530, the activation signal and response signal occur in a single-slot resource.

Any of these resource allocation types are feasible and can in principle coexist in the same resource pool. However, Type C is expected to require a new SL slot design (compared to the NR SL design in NR Release 16) to allow the activation signal and passive device response signal to occur within the same slot. Type A and B are expected to be less disruptive, since these will not impact the SL slot design, as long as both the activation and response signal follow the SL slot structure depicted in FIG. 3A or FIG. 3B.

However, if other SL communications are expected to coexist in the same resource pool, then all of these three resource allocation types may have an impact on the resource allocation. Namely, the resources used for the passive device response signal should not be used by other SL transmissions, both to protect the response signal from interference as well as to protect the other SL transmissions.

Some example embodiments may provide changes to the NR SL mode 2 resource allocation procedure (i.e., UE-autonomous resource selection without network support) to cope with the joint activator UE and passive device transmissions for Type A and B. The activation and passive resources may be paired. If the activation resource has not yet been used (i.e., it is a future resource), then this resource can still be taken over by another SL transmission with higher priority. If the activation resource has already been used, then the passive resource may need to be protected (i.e., no other UE should use it to perform its transmission). However, this condition may be relaxed, if the other UE has a much higher traffic priority.

In some example embodiments, the NR SL Mode 2 resource allocation procedure may be enhanced to support the discovery, charging and activation of passive devices (henceforth called tags) by an SL UE. More specifically, the procedure describes the reservation of resources for a UE transmitting an activation signal (and charging the tag), as well as the resource where the tag(s) is (are) expected to transmit its (their) reply.

This enhancement addresses two challenges: (i) when the resource(s) used for the transmission of the activation signal can be preempted by other UEs, then the activating UE has to perform resource re-selection; and (ii) when the resource(s) to be used by the passive tag are preempted, then the activating UE has to select new resources (for both activation and tag reply), as the tag is assumed unable to detect the occurrence of preemption.

Thus, some example embodiments may enable to reserve resources by one UE by taking into account both the activation channel and response channel, and their potential use by other coexisting UEs. The tag may be assumed to obey the reservations of another device and both ‘links’ influence resource allocation. A resource may not be preferred, if its quality is not sufficient, for example via sensing (measurement-based decision, e.g., LBT) or via reservation (known or assumed interference due to other devices).

Some example embodiments may allow tag communications (and associated charging and activation) to coexist in resource pools, where other non-tag traffic takes place. In this way, there is no need to reserve dedicated resources for these type of communications.

In an example embodiment, the NR SL mode 2 resource allocation procedure may be enhanced to take into account the relation between the different types of resource reservation (i.e., between the charging, activation and tag response signals).

In the enhanced procedure, single slot resource selection may include the selection of the resources for the charging, activation signal as well as the tag response signal.

The reservation of the resources for charging, activation and tag response signal may indicate the purpose of the reserved resource. The rationale for this is that resources indicated for charging can be preempted, regardless of the priority of the traffic, while the preemption of resources indicated for activation and tag response may depend on priority (of both the passive communications and other SL UEs' communications).

The reselection and re-evaluation procedure may take into account the following: 1) preemptions of the resources selected for tag charging do not trigger selection of new resources for charging, since any other transmissions taking place in those resources can still charge the tag; 2) preemptions of the selected resources for activation and tag response triggers the selection of new resources for both; and 3) preemptions of the selected resources for tag reply triggers resource reselection for the activation and tag reply. This reselection may be based on the priority. It should be noted that only the activator or other non-passive SL UEs may perform resource selection and reevaluation (i.e., the tag may not be able to perform resource selection and reevaluation). The tag response may be assumed to occur as a reply to the reception of the activation signal.

Herein the term “preemption” means that a UE takes over the resources that had previously been reserved by another UE.

The mapping between the activation resource and tag response may be defined for example as one of the following: a) a fixed mapping (e.g., defined in specifications), b) a configurable mapping, defined in the resource pool configuration (e.g., in the form of bitmap, distance between resources, frequency hopping); or c) an adaptive mapping, defined in the SCI of the activator).

In the following, the impact of the enhancements are described from the perspective of the different devices involved in the passive and non-passive communications.

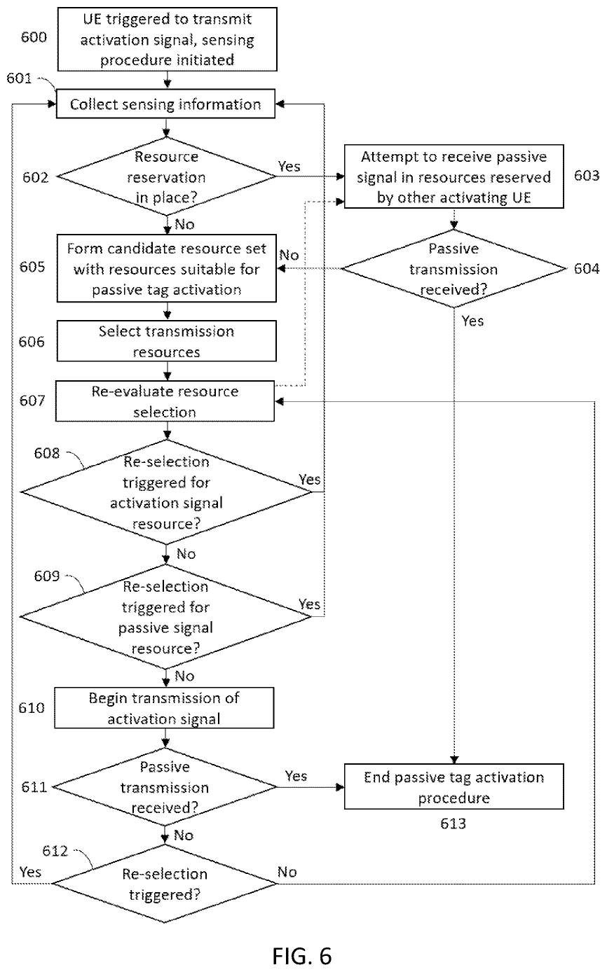

FIG. 6 illustrates a flow chart according to an example embodiment of a method performed by a first device. For example, the first device may be, or comprise, or be comprised in, a user device such as the UE-A/R (activator-reader UE) of FIG. 4A.

Referring to FIG. 6, in block 600, the first device is triggered to transmit an activation signal to a specific tag or group of tags, and thus the sensing procedure for resource selection is initiated. In other words, the first device may receive an indication for triggering the transmission of the activation signal to the tag(s). For example, this trigger may come from: a) the first device's application layer (e.g., due to trigger from the user or automatic trigger from the application associated with the passive tag), or b) the network (e.g., due to a trigger from a network function or from an application at the edge of the network). The tag(s) may also be referred to as a second device herein.

In block 601, the first device is continuously monitoring/sensing the resource pool for the sidelink transmissions of one or more other UEs in order to determine available resources in the resource pool. In other words, the first device is collecting sensing information including reserved resources and SL-RSRP measurements. During this monitoring, the first device may decode the 1st stage SCI and measure the associated RSRP. The 1st stage SCI may indicate if the current resource (as well as the associated future reservation) are associated with passive IoT transmissions. Herein the term “resource” may refer to radio resources, such as time and/or frequency resources.

In case the first device has the role of activator, the first device may also decode the 2nd stage SCI in order to determine if the transmission is from or is directed towards the targeted tag. In case the transmission is from the targeted tag, then the first device may attempt to decode the transport block (TB) transmitted in the associated PSSCH.

In block 602, the first device determines whether there is any future resource reservation (based on the monitoring in block 601), where an activation signal for the targeted tag is expected and/or a tag response is expected. In other words, the first device determines whether there is a resource reservation in place to activate the targeted tag(s).

In case the content of the tag transmission is not expected to change regardless of the first device sending the activation signal, then in case there is no such reservation (block 602: no), the procedure may continue to block 605 following block 602. Otherwise (block 602: yes), the procedure may continue to block 603 following block 602.

In case the content of the tag transmission is expected to change depending on the first device transmitting the activation signal, the procedure may continue to block 605 following block 602.

In block 603, the first device monitors the resources reserved for the tag's responses (i.e., the first device attempts to receive a passive signal in the resources reserved by another activating UE). In other words, based on determining that at least one other device has reserved at least one resource for a transmission from the other device to the second device (tag), and at least one resource for a transmission (response) from the second device (tag), the first device monitors for the transmission from the second device in the at least one resource reserved for the tag response by the at least one other device.

In block 604, following block 603, the first device determines whether there is a transmission present in the reserved resource and attempts to decode the associated TB. In other words, the first device determines whether the passive transmission was received in the reserved resource.

In case no tag transmission was detected in the reserved resource (block 604: no), then this may indicate that the tag requires further charging, and the procedure may continue to block 605 following block 604. In other words, in block 605, the first device may create the set of candidate resources based on not detecting the transmission (response) from the second device (tag), while monitoring for the transmission in the at least one resource reserved by the other device.

In case a tag transmission is detected (i.e., at least the 1st stage SCI is detected and decoded and it is indicated in the 1st stage SCI that it belongs to a passive IoT transmission), but the TB in the associated PSSCH was not decoded successfully, then the procedure may continue to block 605 following block 604.

In case a tag transmission is detected, it belongs to the targeted tag, and the associated TB was decoded successfully (block 604: yes), then the procedure may conclude in block 613 following block 604.

In block 605, the first device forms, or creates, the set of candidate resources, from which a subset of resources is going to be selected to transmit the charging and activation signal(s) and the associated tag response.

The candidate resources may include the resource(s), where the activation signal can be transmitted (which may include one or more resources, since the tag might require multiple rounds to charge) and the resource(s) suitable for the tag response.

In case multiple resources can be configured for charging and/or activation, then the resources for charging may include an indication that these are for charging. In other words, the first device may transmit an indication indicating at least one resource for the charging signal. This indication may be present both during the resource reservation as well as during the actual transmission of the charging signal. The indication during the resource reservation allows other UEs to be aware that they can preempt the charging resource(s) without having to apply the priority criteria to decide whether or not they should preempt the resource. The indication during the actual charging signal transmission has a dual purpose: 1) it allows the tag to transition from receiving to charging mode; and 2) it allows other UEs to stop the decoding of the resource, since it may only contain energy.

The last transmission of this set of transmissions may be the one that carries the activation signal. Since the indication of which tag is the target device may be present in the 2nd stage SCI using the field Destination ID, then the activation signal indication may also be expected to be carried in the 2nd stage SCI.

A valid candidate resource set may comprise one or more resources for the charging/activation signal and at least one resource for the tag response.

In a first example, there may be a mapping between the resource where the activation signal is transmitted and the resource where the tag response is expected. This fixed mapping may be provided in the form of a time offset value (e.g., as a number of slots), where the starting sub-channel is the sub-channel to be used by the tag transmission in the slot indicated by the time offset value. This offset may be part of the specification, or part of the resource pool configuration, or it may be part of the tag operation or part of other network-provided configuration associated with the operation of tags.

In a second example, there may be a configurable mapping defined in the resource pool (e.g., in the form of bitmap, distance between resources, frequency hopping).

In a third example, there may be an adaptive mapping, meaning that the 1st stage SCI of the activating signal reserves the resource to be used for the tag response.

In all three examples above, the 1st stage SCI may be expected to indicate the future reservations resources for either charging, activation or tag response slots. This information in connection to an indication that the resource reservation is for tag activity may be used in the resource selection procedure of other UEs (e.g., to decide whether or not a given resource can be preempted).

A resource may be deemed as a valid candidate resource, when it has not been reserved by another UE in the past, or when reserved but the associated reservation signal (i.e., the 1st stage SCI) is below a configured RSRP threshold. For example, the RSRP threshold may be associated with the priority indicated in the reservation signal (i.e., the transmission priority in the 1st stage SCI). As another example, the RSRP threshold may be associated with the type of transmission. For example, communications associated with passive communications may have a different mapping between RSRP threshold and reservation signal priorities. Alternatively, when detected, resources reserved for passive communications may be excluded from the set of candidate resources.

In block 606, the first device selects the subset of resources that it is going to use for charging, activation, and to receive the tag response. The first device may select the resources semi-persistently, or up to maximum reservations, with starting time ‘m’. The ordering of these resources in time may be: charging, activation, and tag response.

The charging signal and/or activation signal may also be referred to as a first transmission herein. The tag response may also be referred to as a second transmission herein. The subset of resources may comprise at least one first resource for the first transmission and at least one second resource for the second transmission.

In block 607, after selecting the subset of resources (e.g., for charging, activation and tag response), the first device monitors the resource pool for reservations from other UEs with the purpose of detecting whether: a) other UEs have reserved any of the selected resources for the passive communications (e.g., for charging, activation or tag response); and whether other UEs have reserved resources to activate and receive the response of the targeted tag(s). In other words, the first device re-evaluates the resource selection by continuing to decode other UEs' PSCCH and measuring the corresponding PSSCH energy, including reservations intended to activate the same tag.

In case the content of the tag transmission is not expected to change regardless of the first device transmitting the activation signal, when these resources (in particular the resource associated with the reception of the tag transmission) occur before the resources reserved by the first device, then the procedure may continue to block 603 following block 607. Additionally, if the TB of the tag transmission has been decoded successfully (block 604: yes), then the procedure may conclude in block 613. Otherwise, the procedure may continue to block 608 following block 607.

In case the content of the tag transmission is expected to change depending on the first device transmitting the activation signal, the procedure may continue to block 608 following block 607.

In block 608, based on the re-evaluation of block 607, the first device checks whether it needs to trigger the reselection of resources associated with the charging or activation signal, based on the detection that another UE has stated (via a resource reservation indication in the 1st stage SCI of that another UE) that it will be transmitting in those resources. In case the trigger conditions are fulfilled (block 608: yes), then the procedure may return to block 601 following block 608. Otherwise (block 608: no), the procedure may continue to block 609 following block 608.

In case another UE preempts the resources selected/reserved for charging, the first device may not perform a resource reselection for this transmission. The first device may then still decide whether or not to proceed with the charging signal transmission in the selected resource for charging, based for example on whether the RSRP associated with the another UE resource reservation is above a configured threshold.

In block 609, based on the re-evaluation of block 607, the first device checks whether it needs to trigger the reselection of the resources associated with the activation signal and tag response, based on the detection that another UE has stated (via a resource reservation indication in the 1st stage SCI of that other UE) that it will be transmitting in the resource associated with the tag response. In other words, the first device determines whether one or more other devices have reserved one or more resources conflicting with the at least one second resource. In case the trigger conditions are fulfilled (block 609: yes), then the procedure may return to block 601 following block 609. Otherwise (block 609: no), the procedure may continue to block 610 following block 609.

In block 610, the first device initiates the transmission of the charging and activation signals in their respective slots. In other words, the first device transmits the first transmission to the tag (second device) in the at least one first resource based at least on determining that the one or more other devices have not reserved resources conflicting with the at least one second resource. As part of this transmission, the first device may indicate the future resources (in its 1st stage SCI), where additional charging slots and/or activation signal slot will take place, as well as the slot (i.e., the at least one second resource) where the tag response is expected. The future resources may be in the short term or in the long term.

In the short term (short-term aperiodic transmissions), for example in NR SL per NR Release 17, it is allowed to indicate up to 2 additional resources within a period of 32 slots starting from when the initial transmission occurs. This would be indicated in the Frequency and Time resource assignment fields of the 1st stage SCI of the initial transmission.

In the long term (periodic transmissions), for example in NR SL per NR Release 17, it is allowed to indicate a resource reservation period, which informs all the UEs in the resource pool when the first device is expected to perform a transmission again.

The charging signal towards the tag may include a charging indication, which may be, for example, in the form of an indication in the 1st or 2nd stage SCI, or it may be a signal sequence (e.g., a Zadoff-Chu sequence) taking place in one or several resource elements of the SL resource selected for the charging signal transmission.

The activation signal may include an activation indication, which may be, for example, in the form of an indication in the 1st or 2nd stage SCI, or it may be a signal sequence (e.g., a Zadoff-Chu sequence) taking place in one or several resource elements of the SL resource selected for the activation signal transmission.

In block 611, after the charging and activation signals have been transmitted in their respective slots, the first device checks whether the tag provides a response in the associated reserved resource. In other words, the first device monitors for the second transmission from the second device in the at least one second resource. If the response (second transmission) is received from the tag (block 611: yes), then the procedure may be concluded in block 613 following block 611. Otherwise (block 611: no), the procedure may continue to block 612 following block 611.

In block 612, the first device checks whether it needs to select new resources. In case of short-term aperiodic transmissions, the procedure may return to block 601 following block 612 (i.e., to restart the procedure). In case of periodic transmissions, the procedure may return to block 601, if the maximum number of allowed periodic reservation has been reached. Otherwise, the procedure may return to block 607 following block 612.

In block 613, the first device has been able to detect the tag and therefore concludes the procedure. The first device may report the content of the tag transmission payload to the network or to its own upper layers for further processing.

For the case where there is a UE taking the activator role and another UE taking the reader role, the procedure at the activator UE side may be the same as described above with reference to FIG. 6. However, there may be an additional trigger to initiate the procedure. For example, if the reader UE does not detect the tag transmission, then it may request the activator UE to initiate the procedure.

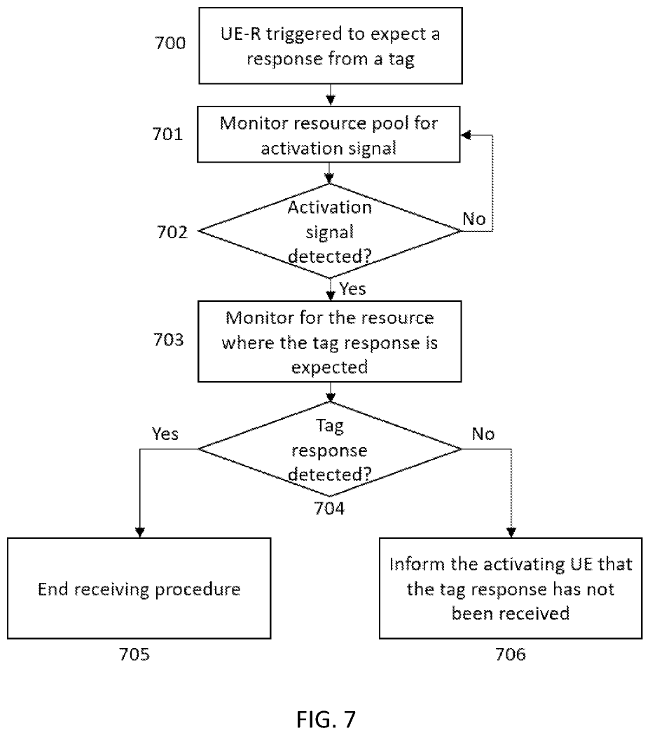

FIG. 7 illustrates a flow chart according to an example embodiment of a method performed by a third device. For example, the third device may be, or comprise, or be comprised in, a user device such as the UE-R (reader UE) of FIG. 4B.

Referring to FIG. 7, in block 700, the reader UE is triggered to expect a response from a tag. For example, this trigger may be an indication from the network, or a direct indication from the activator UE, or an indirect indication based on the detection of an activation signal. This trigger may include information about the ID of the tag that is expected to respond, for example in the form an L2 ID or other identifier that can be mapped to the Destination ID field in the 2nd stage SCI.

In block 701, based on the trigger, the reader UE monitors the activity in the resource pool for the occurrence of the activation signal, as well as the indication of the resource(s) where the tag is expected to provide its response. The activation signal may also be referred to as a first transmission herein. The tag response may also be referred to as a second transmission herein. In other words, the reader UE monitors the resource pool for the first transmission from the activator UE (first device) to the tag (second device).

For example, the detection of the activation signal may be based on the detection of an activation indication, which may be in the form of an indication in the 1st or 2nd stage SCI, or it may be a signal sequence (e.g., a Zadoff-Chu sequence) taking place in one or more resource elements of the SL resource selected for the activation signal transmission.

The 2nd stage SCI may include the ID of the targeted tag.

In block 702, in case the activation signal has not been detected (block 702: no), then the procedure may return to block 701 following block 702. Otherwise, if the activation signal (first transmission) is detected (block 702: yes), the procedure may continue to block 703 following block 702.

In block 703, the reader UE starts monitoring the resource(s) where the tag response is expected to be received. In other words, the reader UE monitors for the second transmission (tag response) from the second device (tag) in the at least one resource indicated by the first transmission (activation signal).

In block 704, the reader UE checks whether the tag response has been received. In case the tag response has been received (block 704: yes), then the procedure may continue to block 705 following block 704. Otherwise (block 704: no), the procedure may continue to block 706 following block 704.

In block 705, the reader UE has been able to successfully detect the tag response (and additionally or optionally collect the payload from the tag response, if any) and therefore concludes the procedure. The reader UE may report the content of the tag response payload to the network or to its own upper layers for further processing. The reader UE may transmit an indication to the activating UE (first device) to indicate that the tag response has been received successfully.

In block 706, in case of not receiving the tag response in the expected resource, the reader UE may transmit an indication to the activating UE (first device) to indicate that the tag response has not been received, and thus trigger the activating UE to re-initiate the tag charging/activation procedure.

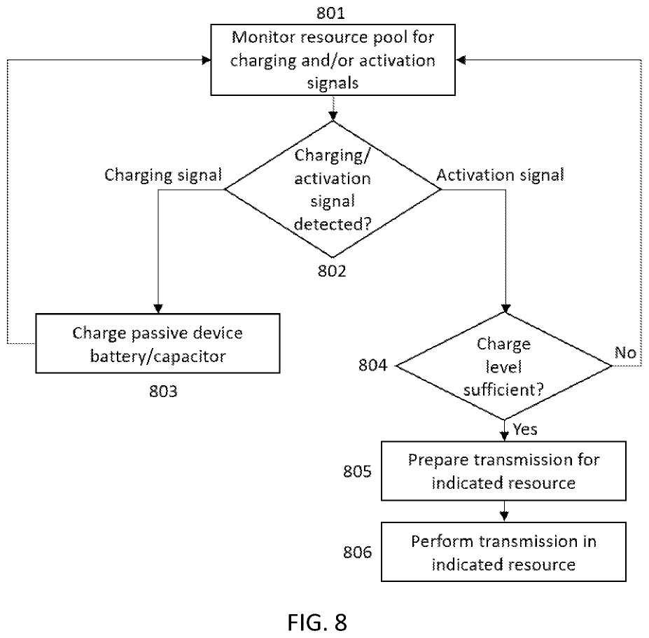

FIG. 8 illustrates a flow chart according to an example embodiment of a method performed by a second device. For example, the second device may be, or comprise, or be comprised in, a user device such as the tag (passive device) of FIG. 4A or FIG. 4B, or a device in part comprising a passive device or passive processing, or any other communication device.

Referring to FIG. 8, in block 801, the tag monitors the resource pool for charging and/or activation signals (first transmission) from an activating UE (first device).

In block 802, the tag checks whether a charging signal or activation signal has been detected. In other words, the tag determines whether the first transmission received from the first device comprises a charging signal or an activation signal. If a charging has been detected, the procedure may continue to block 803 following block 802. If an activation signal has been detected, the procedure may continue to block 804 following block 802.

In block 803, in case a charging signal has been detected (i.e., there is an indication that the tag should use the received energy to charge), then the tag uses the energy harvested from the first transmission to charge its battery or capacitor. The procedure may return to block 801 following block 803, i.e., the tag may continue to monitor the resource pool for an additional charging signal or for the activation signal from the first device.

In block 804, in case an activation signal has been received, the tag checks whether it has acquired enough charge to perform a transmission. In other words, the tag determines whether its charge level is above a threshold. In case the charge level is not sufficient (block 804: no), for example if the charge level is below the threshold, then the procedure may return to block 801 following block 804. In case the charge level is sufficient (block 804: yes), for example if the charge level is above the threshold, then the procedure may continue to block 805 following block 804.

In block 805, the tag prepares the response transmission (i.e., the TB to be transmitted) for the resource(s) indicated by the activation signal, and prepares the 1st and 2nd stage SCI to be included in the response transmission.

In block 806, following block 805, the tag performs the response transmission in the resource(s) indicated by the activation signal. The response transmission may also be referred to as a second transmission herein.

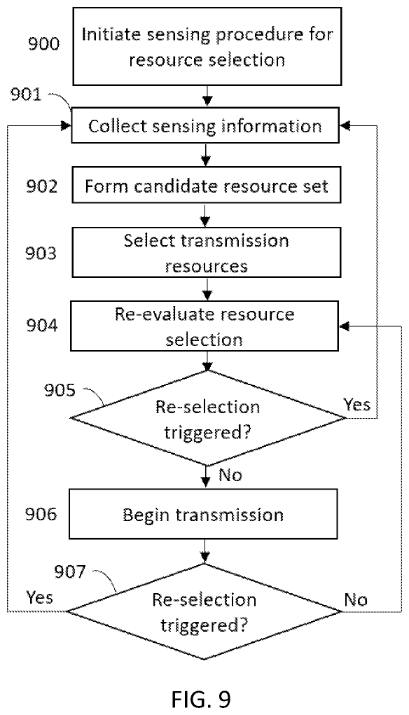

FIG. 9 illustrates a flow chart according to an example embodiment of a method performed by a fourth device. For example, the fourth device may be, or comprise, or be comprised in, a user device such as a non-activating UE.

Referring to FIG. 9, in block 900, the fourth device is informed by its upper layers that it has data to transmit, and therefore the fourth device initiates the sensing procedure for resource selection.

In block 901, the fourth device is continuously monitoring/sensing the resource pool for sidelink transmissions from other UEs in order to determine available resources in the resource pool. In other words, the fourth device collects sensing information including reserved resources and SL-RSRP measurements.

During this monitoring, the fourth device may decode the 1st stage SCI and measure the associated RSRP.

In block 902, based on the available resources, the fourth device forms the set of candidate resources, from which a subset of resources is going to be selected to perform its transmission. The set of candidate resources may comprise one or more resources suitable for a first transmission from the fourth device.

If the passive communications need to be protected from non-passive communication transmissions, then the resources associated with passive communications (e.g., the activation signal and tag response signal) may be excluded from the set of candidate resources. In other words, resources associated with activation signals to one or more passive devices (tags), and resources associated with transmissions from the one or more passive devices (tags) may be excluded from the set of candidate resources. This exclusion may be accomplished based on the indication on the 1st stage SCI of the passive communications that a given resource reservation is associated with passive communications.

The resources associated with charging may not be excluded from the set of candidate resources. In other words, resources associated with charging signals to the one or more passive devices (tags) may be included in the set of candidate resources.

When the passive communication resources can be preempted by other communications (e.g., based on priority), a resource may be deemed as valid to be included in the set of candidate resources, if it has not been reserved by another UE in the past, or when reserved but the associated reservation signal (i.e., the 1st stage SCI) is below a configured RSRP threshold. For example, the RSRP threshold may be associated with the priority indicated in the reservation signal (i.e., the transmission priority in the 1st stage SCI). As another example, the RSRP threshold may be associated with the type of transmission. For example, communications associated with passive communications may have a different mapping between RSRP threshold and reservation signal priorities.

In case a reserved resource is indicated to be for passive communications, then the fourth device may apply an RSRP threshold associated with passive communications and associated priority.

In block 903, the fourth device selects the resources that it is going to use for transmission. The fourth device may select the transmission resources semi-persistently, or up to maximum reservations, with starting time ‘m’.

In block 904, upon having selected the resources, the fourth device monitors the resource pool for reservations from other UEs with the purpose of detecting if any other UEs have reserved the same resources. Thus, the fourth device may re-evaluate the resource selection by continuing to decode the PSCCH of other UEs and measuring the corresponding PSSCH energy.

In block 905, the fourth device checks whether it needs to trigger the reselection of its resources based on the re-evaluation, i.e., based on detecting whether another UE has stated (via a resource reservation indication in the 1st stage SCI of that other UE) that it will be transmitting in those resources. In case the trigger conditions are fulfilled (block 905: yes), then the procedure may return to block 901 following block 905. In case the trigger conditions are not fulfilled (block 905: no), then the procedure may continue to block 906 following block 905.

In block 906, the fourth device performs its transmission.

In block 907, the fourth device checks if it needs to select new resources. In the case of short-term aperiodic transmissions, the procedure may return to block 901 following block 906. In case of periodic transmissions, the procedure may return to block 901 following block 906, if the maximum number of allowed periodic reservation has been achieved. Otherwise, the procedure may return to block 904 following block 906.

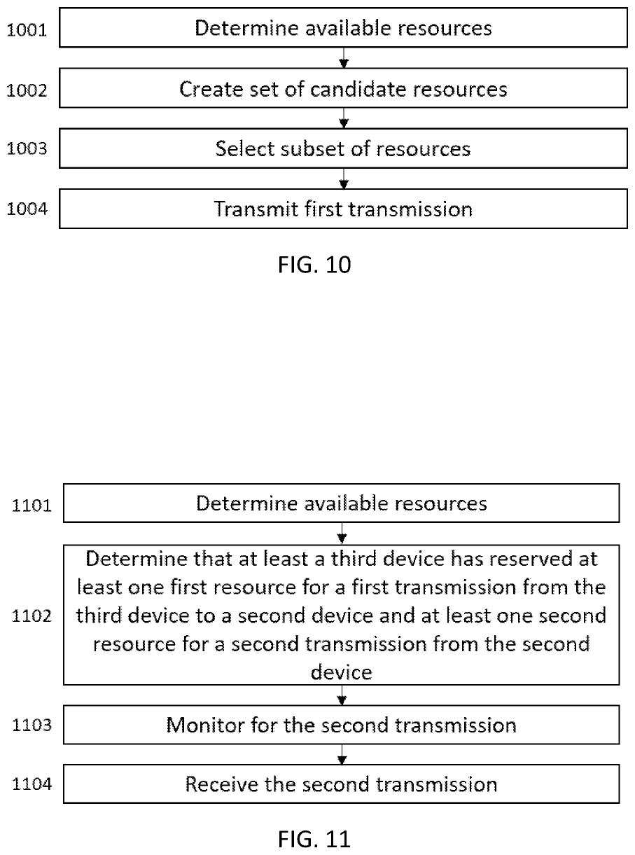

FIG. 10 illustrates a flow chart according to an example embodiment of a method performed by a first device. For example, the first device may be, or comprise, or be comprised in, a user device such as the UE-A/R (activator-reader UE) of FIG. 4A, or the UE-A (activator UE) of FIG. 4B.

Referring to FIG. 10, in block 1001, available resources in a resource pool are determined based at least partly on channel sensing or channel occupancy information.

The channel sensing may mean, for example, monitoring transmissions from one or more other devices in the resource pool.

The channel occupancy information may comprise, for example, information of interference or resources already in use by other nearby devices.

In block 1002, based on the available resources, a set of candidate resources is created, the set of candidate resources comprising one or more first resources suitable for a first transmission from the first device to a second device, and one or more second resources suitable for a second transmission from the second device to the first device or to a third device.

The second device may comprise a passive device (e.g., tag) or any other communication device.

In block 1003, a subset of resources is selected from the set of candidate resources, wherein the subset of resources comprises at least one first resource for the first transmission and at least one second resource for the second transmission.

In block 1004, the first transmission is transmitted to the second device in the at least one first resource, wherein the first transmission indicates the at least one second resource for the second transmission from the second device.

The first transmission may comprise at least one of the following: an activation signal indicating the at least one second resource for the second transmission, and/or a charging signal for charging a battery or a capacitor of the second device by harvesting energy from the charging signal.

Herein the terms “first resource” and “second resource” are used to distinguish the resources, and they do not necessarily mean specific identifiers of the resources.

FIG. 11 illustrates a flow chart according to an example embodiment of a method performed by a first device. For example, the first device may be, or comprise, or be comprised in, a user device such as the UE-A/R (activator-reader UE) of FIG. 4A, or the UE-A (activator UE) of FIG. 4B.

Referring to FIG. 11, in block 1101, available resources in a resource pool are determined based at least partly on channel sensing or channel occupancy information.

The channel sensing may mean, for example, monitoring transmissions from one or more other devices in the resource pool.

The channel occupancy information may comprise, for example, information of interference or resources already in use by other nearby devices.

In block 1102, the first device determines that at least a third device has reserved at least one first resource for a first transmission from the third device to a second device and at least one second resource for a second transmission from the second device.

In block 1103, the first device monitors for the second transmission from the second device in the at least one second resource reserved by the third device.

In block 1104, the second transmission is received from the second device in the at least one second resource reserved by the third device.

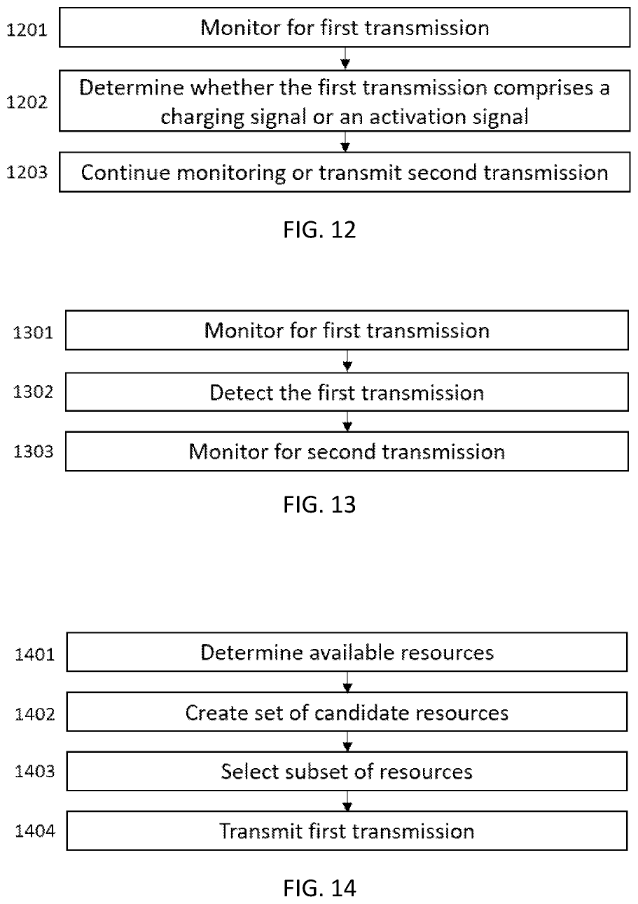

FIG. 12 illustrates a flow chart according to an example embodiment of a method performed by a second device. For example, the second device may be, or comprise, or be comprised in, a user device such as the tag (passive device) of FIG. 4A or FIG. 4B, or a device in part comprising a passive device or passive processing, or any other communication device.

Referring to FIG. 12, in block 1201, the second device monitors a resource pool for a first transmission from a first device.

In block 1202, the second device determines whether the first transmission received from the first device comprises a charging signal or an activation signal.

In block 1203, the second device performs one of the following: continues to monitor the resource pool for an additional charging signal or for the activation signal from the first device based on determining that the first transmission comprises the charging signal, or transmits a second transmission in at least one resource indicated by the activation signal based on determining that the first transmission comprises the activation signal.

In other words, if the first transmission comprises the charging signal, then the second device may continue to monitor the resource pool for an additional charging signal or for the activation signal. Alternatively, if the first transmission comprises the activation signal, then the second device may transmit the second transmission in the at least one resource indicated by the activation signal.

FIG. 13 illustrates a flow chart according to an example embodiment of a method performed by a third device. For example, the third device may be, or comprise, or be comprised in, a user device such as the UE-R (reader UE) of FIG. 4B.

Referring to FIG. 13, in block 1301, the third device monitors a resource pool for a first transmission from a first device to a second device.

In block 1302, the first transmission is detected, wherein the first transmission indicates at least one resource for a second transmission from the second device.

In block 1303, the third device monitors for the second transmission from the second device in the at least one resource.

FIG. 14 illustrates a flow chart according to an example embodiment of a method performed by a fourth device. For example, the fourth device may be, or comprise, or be comprised in, a user device such as a non-activating UE.

Referring to FIG. 14, in block 1401, available resources in a resource pool are determined based at least partly on channel sensing or channel occupancy information.

The channel sensing may mean, for example, monitoring transmissions from one or more other devices in the resource pool.

The channel occupancy information may comprise, for example, information of interference or resources already in use by other nearby devices.

In block 1402, based on the available resources, a set of candidate resources is created, the set of candidate resources comprising one or more resources suitable for a first transmission from the fourth device, wherein resources associated with transmissions from one or more passive devices are excluded from the set of candidate resources.

Resources associated with charging signals to the one or more passive devices may be included in the set of candidate resources.

In block 1403, a subset of resources is selected from the set of candidate resources, wherein the subset of resources comprises at least one resource for the first transmission.

In block 1404, the first transmission is transmitted in the at least one resource.

The blocks, related functions, and information exchanges (messages) described above by means of FIGS. 6-14 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

Herein, the terms “first device”, “second device”, “third device”, and “fourth device” are used to distinguish the devices, and they do not necessarily mean specific identifiers of the devices.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

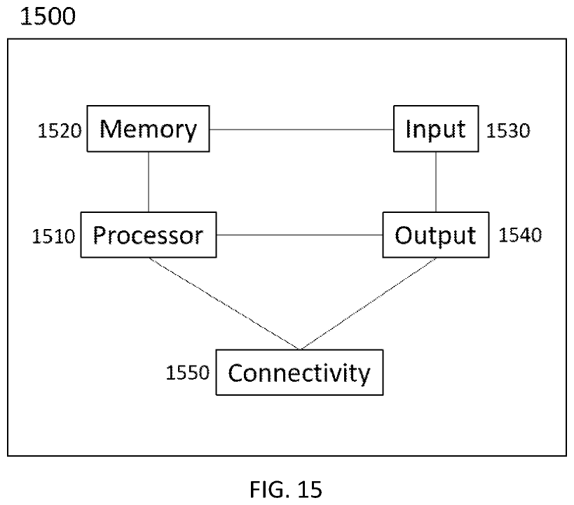

FIG. 15 illustrates an example of an apparatus 1500 comprising means for performing one or more of the example embodiments described above. For example, the apparatus 1500 may be an apparatus such as, or comprising, or comprised in, a user device. The user device may correspond to one of the user devices 100, 102 of FIG. 1. The user device may also be called a subscriber unit, mobile station, remote terminal, access terminal, user terminal, terminal device, user equipment (UE), UE-A, UE-A/R, UE-R, passive device, passive IoT device, tag, first device, second device, third device, or fourth device.

The apparatus 1500 may comprise a circuitry or a chipset applicable for realizing one or more of the example embodiments described above. For example, the apparatus 1500 may comprise at least one processor 1510. The at least one processor 1510 interprets instructions (e.g., computer program instructions) and processes data. The at least one processor 1510 may comprise one or more programmable processors. The at least one processor 1510 may comprise programmable hardware with embedded firmware and may, alternatively or additionally, comprise one or more application-specific integrated circuits (ASICs).

The at least one processor 1510 is coupled to at least one memory 1520. The at least one processor is configured to read and write data to and from the at least one memory 1520. The at least one memory 1520 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 1520 stores computer readable instructions that are executed by the at least one processor 1510 to perform one or more of the example embodiments described above. For example, non-volatile memory stores the computer readable instructions, and the at least one processor 1510 executes the instructions using volatile memory for temporary storage of data and/or instructions. The computer readable instructions may refer to computer program code.

The computer readable instructions may have been pre-stored to the at least one memory 1520 or, alternatively or additionally, they may be received, by the apparatus, via an electromagnetic carrier signal and/or may be copied from a physical entity such as a computer program product. Execution of the computer readable instructions by the at least one processor 1510 causes the apparatus 1500 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 1500 may further comprise, or be connected to, an input unit 1530. The input unit 1530 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1530 may comprise an interface to which external devices may connect to.

The apparatus 1500 may also comprise an output unit 1540. The output unit may comprise or be connected to one or more displays capable of rendering visual content, such as a light emitting diode (LED) display, a liquid crystal display (LCD) and/or a liquid crystal on silicon (LCoS) display. The output unit 1540 may further comprise one or more audio outputs. The one or more audio outputs may be for example loudspeakers.

The apparatus 1500 further comprises a connectivity unit 1550. The connectivity unit 1550 enables wireless connectivity to one or more external devices. The connectivity unit 1550 comprises at least one transmitter and at least one receiver that may be integrated to the apparatus 1500 or that the apparatus 1500 may be connected to. The at least one transmitter comprises at least one transmission antenna, and the at least one receiver comprises at least one receiving antenna. The connectivity unit 1550 may comprise an integrated circuit or a set of integrated circuits that provide the wireless communication capability for the apparatus 1500. Alternatively, the wireless connectivity may be a hardwired application-specific integrated circuit (ASIC). The connectivity unit 1550 may also provide means for performing at least some of the blocks of one or more example embodiments described above. The connectivity unit 1550 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1500 may further comprise various components not illustrated in FIG. 15. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1. A first device comprising at least one processor, and at least one memory storing instructions which, when executed by the at least one processor, cause the first device at least to:
determine available resources in a resource pool based at least partly on channel sensing or channel occupancy information;
create, based on the available resources, a set of candidate resources comprising one or more first resources suitable for a first transmission from the first device to a second device, and one or more second resources suitable for a second transmission from the second device to the first device or to a third device;
select a subset of resources from the set of candidate resources, wherein the subset of resources comprises at least one first resource for the first transmission and at least one second resource for the second transmission; and
transmit the first transmission to the second device in the at least one first resource, wherein the first transmission indicates the at least one second resource for the second transmission from the second device.

2. The first device according to claim 1, further being caused to:
receive an indication for triggering the first transmission to the second device, wherein the determining, the creating, the selecting and the transmitting are performed based on receiving the indication.

3. The first device according to claim 1, wherein the first transmission comprises at least one of the following: an activation signal indicating the at least one second resource for the second transmission, or a charging signal for charging a battery or a capacitor of the second device by harvesting energy from the charging signal.

4. The first device according to claim 1, further being caused to:
monitor for the second transmission in the at least one second resource; and
receive the second transmission from the second device in the at least one second resource.

5. The first device according to claim 1, wherein the channel sensing comprises monitoring transmissions from one or more other devices in the resource pool.

6. The first device according to claim 5, further being caused to:
determine that at least one of the one or more other devices has reserved at least one third resource for a third transmission from the second device; and
monitor for the third transmission from the second device in the at least one third resource,
wherein the set of candidate resources is created based on not detecting the third transmission, while monitoring for the third transmission.

7. The first device according to claim 5, further being caused to:
determine whether the one or more other devices have reserved one or more resources conflicting with the at least one second resource,
wherein the first transmission is transmitted to the second device based at least on determining that the one or more other devices have not reserved resources conflicting with the at least one second resource.

8. The first device according to claim 1, further being caused to:
transmit an indication indicating the at least one first resource.

9. (canceled)

10. A second device comprising at least one processor, and at least one memory storing instructions which, when executed by the at least one processor, cause the second device at least to:
monitor a resource pool for a first transmission from a first device;
determine whether the first transmission received from the first device comprises a charging signal or an activation signal; and
perform one of the following: continue to monitor the resource pool for an additional charging signal or for the activation signal from the first device based on determining that the first transmission comprises the charging signal, or transmit a second transmission in at least one resource indicated by the activation signal based on determining that the first transmission comprises the activation signal.

11. The second device according to claim 10, further being caused to:
based on determining that the first transmission comprises the charging signal, charge a battery or a capacitor by harvesting energy from the first transmission, wherein the charging signal indicates to perform the charging.

12. The second device according to claim 10, further being caused to:
based on determining that the first transmission comprises the activation signal, determine whether a charge level of the apparatus is above a threshold,
wherein the second transmission is transmitted based on determining that the charge level is above the threshold.

13. The second device according to claim 10, wherein the second device comprises a passive device.

14. A third device comprising at least one processor, and at least one memory storing instructions which, when executed by the at least one processor, cause the third device at least to:
monitor a resource pool for a first transmission from a first device to a second device;
detect the first transmission, wherein the first transmission indicates at least one resource for a second transmission from the second device; and
monitor for the second transmission from the second device in the at least one resource.

15. The third device according to claim 14, further being caused to:
receive an indication indicating to expect the second transmission from the second device, wherein the monitoring for the second transmission from the second device is based at least partly on the indication.

16. The third device according to claim 14, further being caused to:
detect the second transmission from the second device in the at least one resource.

17. The third device according to claim 16, further being caused to:
transmit, to the first device, an indication indicating that the second transmission from the second device has been received successfully.

18. The third device according to claim 14, further being caused to:
transmit, to the first device, an indication indicating that the second transmission from the second device has not been received.

19-24. (canceled)
